(19) United States
(12) Patent Application Publication
(10) Pub. No.: US 2024/0361744 A1
(43) Pub. Date: Oct. 31, 2024

(54) INFORMATION PROCESSING APPARATUS, CONTROL METHOD, ROBOT SYSTEM, ARTICLE MANUFACTURING METHOD, AND RECORDING MEDIUM

(71) Applicant: CANON KABUSHIKI KAISHA, Tokyo (JP)

(72) Inventors: YASUHARU MAEDA, Kanagawa (JP); HIRONOBU SASAKI, Kanagawa (JP)

(21) Appl. No.: 18/645,093

(22) Filed: Apr. 24, 2024

(30) Foreign Application Priority Data
Apr. 27, 2023 (JP) 2023-073767

(51) Int. Cl. G05B 19/402

(52) U.S. Cl. CPC G05B 19/402; G05B 2219/40522; G05B 2219/40572

(57) ABSTRACT

An information processing apparatus includes at least one memory storing instructions; and at least one processor that, upon execution of the stored instructions, configures the at least one processor acquire data representing a plurality of portions of a workpiece to be imaged by an imaging unit and acquire first information used in a case where a moving unit that is configured to move the workpiece or the imaging unit moves the workpiece or the imaging unit so as to have a first positional relationship in which a multiple number of portions among the plurality of portions of the workpiece are included in the imaging range.

### BACKGROUND

### Field

The present invention relates to an information processing apparatus, a control method, a robot system, an article manufacturing method, and a recording medium.

### Description of the Related Art

Hitherto, as an appearance inspection system for inspecting a state of a surface of a workpiece or an assembly state, a configuration is known in which a robot grips a camera or a workpiece and operates to image a plurality of positions on the workpiece with the camera. As such a robot system for appearance inspection, a technology is disclosed that makes it possible to construct an operation program for designating a surface to be inspected in a workpiece and operating a robot to image the designated surface (see JP 2018-132331 A).

### SUMMARY

According to a first aspect of the present disclosure, an information processing apparatus includes at least one memory storing instructions; and at least one processor that, upon execution of the stored instructions, configures the at least one processor acquire data representing a plurality of portions of a workpiece to be imaged by an imaging unit and acquire first information used in a case where a moving unit that is configured to move the workpiece or the imaging unit moves the workpiece or the imaging unit so as to have a first positional relationship in which a multiple number of portions among the plurality of portions of the workpiece are included in the imaging range.

According to a second aspect of the present disclosure, a control method includes setting a plurality of portions of a workpiece to be imaged by an imaging unit configured to image the workpiece in a predetermined imaging range; and causing a moving unit to move the workpiece or the imaging unit so as to have a first positional relationship in which a multiple number of portions among the plurality of portions of the workpiece are included in the imaging range.

Further features of the present disclosure will become apparent from the following description of exemplary embodiments with reference to the attached drawings.

### BRIEF DESCRIPTION OF THE DRAWINGS

FIG. 1 is a schematic view of a robot system according to a first embodiment of the present disclosure.

FIG. 2 is a view illustrating a configuration of a robot according to the first embodiment of the present disclosure.

FIG. 3 is a view illustrating a simulation apparatus according to the first embodiment of the present disclosure.

FIG. 4 is a control block diagram of an information processing apparatus including a control apparatus and the simulation apparatus according to the first embodiment of the present disclosure.

FIG. 5 is a flowchart illustrating a process of acquiring data of a teaching point for the robot, the process being executed by a central processing unit (CPU) of the simulation apparatus according to the first embodiment of the present disclosure.

FIG. 6 is a view illustrating an example of a configuration of a screen displayed on a display when an input of an inspection position by an operator is received in the simulation apparatus according to the first embodiment of the present disclosure.

FIG. 7 is a view illustrating an example of a configuration of a screen displayed on the display when an input of an imaging range of a camera by the operator is received in the simulation apparatus according to the first embodiment of the present disclosure.

FIG. 8 is a flowchart illustrating a process related to acquisition of data of a teaching point at which a plurality of inspection positions fall within an imaging range of the camera, the process being executed by the CPU according to the first embodiment of the present disclosure.

FIG. 9 is a view illustrating an example of a state in which a plurality of inspection positions are set on a workpiece in the simulation apparatus according to the first embodiment of the present disclosure.

FIG. 10A is a diagram illustrating a state in which principal component vectors and secondary component vectors of inspection positions according to the first embodiment of the present disclosure are calculated.

FIG. 10B is a diagram illustrating acquisition of a rectangle including all inspection positions included in a candidate list from values calculated in FIG. 10A.

FIG. 11A is a view illustrating a state in which an inspection position i1 is added to the candidate list and a rectangle including the inspection position i1 is acquired.

FIG. 11B is a view illustrating a state in which an inspection position i2 is added to the candidate list and a rectangle including the inspection positions i1 and i2 is acquired.

FIG. 11C is a view illustrating a state in which an inspection position i3 is added to the candidate list and a rectangle including the inspection positions i1 to i3 is acquired.

FIG. 11D is a view illustrating a state in which an inspection position i4 is added to the candidate list and a rectangle including the inspection positions i1 to i4 is acquired.

FIG. 11E is a view illustrating a state in which an inspection position i5 is added to the candidate list and a rectangle including the inspection positions i1 to i5 is acquired.

FIG. 11F is a view illustrating a state in which an inspection position i6 is added to the candidate list and a rectangle including the inspection positions i1 to i6 is acquired.

FIG. 12A is a view illustrating a state in which the inspection position i6 is added to the candidate list after a rectangle used in acquiring data of a teaching point for imaging the inspection positions i1 to i5 is acquired, and a rectangle including the inspection position i6 is acquired.

FIG. 12B is a view illustrating a state in which an inspection position i is added to the candidate list and a rectangle including the inspection positions i6 and i is acquired.

FIG. 12C is a view illustrating a state in which an inspection position i8 is added to the candidate list and a rectangle including the inspection positions i6 to i8 is acquired.

FIG. 12D is a view illustrating a state in which an inspection position i9 is added to the candidate list and a rectangle including the inspection positions i6 to i9 is acquired.

FIG. 12E is a view illustrating a state in which an inspection position i10 is added to the candidate list and a rectangle including the inspection positions i6 to i10 is acquired.

FIG. 12F is a view illustrating a state in which an inspection position i11 is added to the candidate list and a rectangle including the inspection positions i6 to i11 is acquired.

FIG. 13 is a view illustrating a state in which data of teaching points for imaging all the inspection positions according to the first embodiment of the present disclosure is acquired.

FIG. 14 is a view illustrating an example of a configuration of a screen when data of a teaching point acquired in the simulation apparatus according to the first embodiment of the present disclosure and an inspection position included in an imaging range when imaged by the camera based on the data of the teaching point are displayed on the display.

FIG. 15 is a flowchart illustrating a process of acquiring data of a teaching point for a robot, the process being executed by a CPU of a simulation apparatus according to a second embodiment of the present disclosure.

FIG. 16 is a view illustrating an example of a configuration of a screen displayed on a display when an input of an imaging range of a camera by an operator is received in the simulation apparatus according to the second embodiment of the present disclosure.

FIG. 17 is a flowchart illustrating a process related to acquisition of data of a teaching point at which a plurality of inspection positions fall within an imaging range of the camera, the process being executed by the CPU according to the second embodiment of the present disclosure.

FIG. 18 is a flowchart illustrating a process of acquiring data of a teaching point for a robot, the process being executed by a CPU of a simulation apparatus according to a third embodiment of the present disclosure.

FIG. 19 is a view illustrating an example of a configuration of a screen displayed on a display when an input of data of an inspection position by an operator is received in the simulation apparatus according to the third embodiment of the present disclosure.

FIG. 20 is a flowchart illustrating a process related to acquisition of data of a teaching point at which a plurality of inspection positions fall within an imaging range of a camera, the process being executed by the CPU according to the third embodiment of the present disclosure.

FIG. 21 is a flowchart illustrating a process of acquiring data of a teaching point for a robot, the process being executed by a CPU of a simulation apparatus according to a fourth embodiment of the present disclosure.

FIG. 22 is a view illustrating an example of a configuration of a screen displayed on a display when an input of a position of an imaging range by an operator is received in the simulation apparatus according to the fourth embodiment of the present disclosure.

### DESCRIPTION OF THE EMBODIMENTS

The apparatus described in JP 2018-132331 A is configured to calculate an operation program for achieving a positional relationship between a workpiece and a camera for imaging each designated portion to be inspected. Therefore, there is a problem that the number of times the robot operates increases as the number of portions of the workpiece to be inspected increases, and a time required for imaging becomes longer.

Therefore, the present disclosure provides a technique capable of improving an efficiency of an imaging operation in a case of imaging a plurality of positions on a workpiece.

### First Embodiment

Hereinafter, a mode for carrying out the present disclosure will be described in detail with reference to the drawings. Note that configurations described below are merely examples, and detailed configurations can be appropriately changed by those skilled in the art without departing from the gist of the present disclosure. In addition, numerical values in the following description are reference numerical values and are merely examples.

### Configuration of Robot System

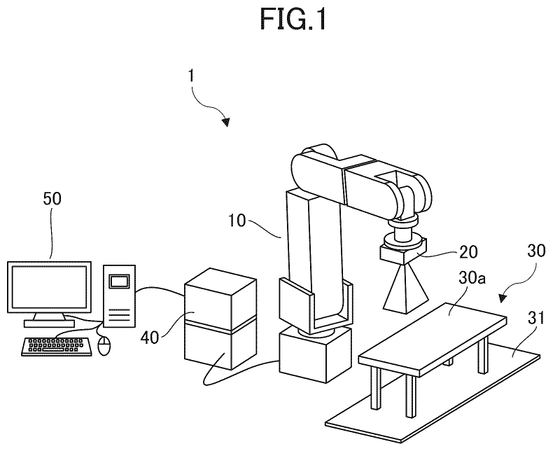

FIG. 1 is an explanatory view illustrating a robot system 1 according to a first embodiment. In the first embodiment, a robot system that performs appearance inspection on an inspection surface 30a that is an arbitrary plane of a workpiece 30 by using a camera 20 gripped by a robot 10 as illustrated in FIG. 1 will be described as an example. In other words, the robot system 1 according to the first embodiment is a robot system in which the robot 10, the camera 20, and the workpiece 30 are set as constituent elements, and performs appearance inspection on an inspection target in a two-dimensional space.

The workpiece 30 is installed on a fixing base 31. The robot 10 is connected to a control apparatus 40. The control apparatus 40 is connected to a simulation apparatus 50. An operator operates the simulation apparatus 50 to acquire data of a teaching point for the robot 10 necessary for appearance inspection.

### Configuration of Robot

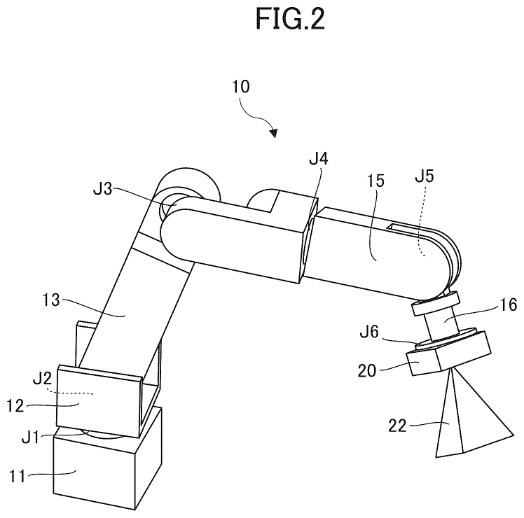

FIG. 2 is a view illustrating a configuration of the robot 10 according to the first embodiment. As illustrated in FIG. 2, the robot 10 is a vertical articulated robot having six rotary joints. The robot 10 has a base 11 as a base end, a link 12 is connected to the base 11 via a joint J1, a link 13 is connected to the link 12 via a joint J2, and a link 14 is connected to the link 13 via a joint J3. In the robot 10, a link 15 is connected to the link 14 via a joint J4, a link 16 is connected to the link 15 via a joint J5, and the camera 20 is connected to the link 16 via a joint J6.

The camera 20 serving as an imaging unit is configured to be able to image the workpiece 30 (see FIG. 1) within an imaging range 22. The size of the imaging range 22 of the camera 20 can be designated by the operator, and imaging is performed within the imaging range 22 having a designated predetermined size. Although the imaging range 22 is depicted in a visible manner to clarify the imaging range 22 in FIG. 2, the imaging range 22 is actually an invisible range.

The robot 10 is connected to the control apparatus 40 and operates according to a command from the control apparatus 40. The operator can input a robot program to the control apparatus 40 to perform appearance inspection by an operation of the robot 10 and imaging by the camera 20. In other words, the control apparatus 40 is configured to be able to execute a process of operating the robot 10 to move the camera 20 and a process of imaging the workpiece 30 by the camera 20 capable of pointing the workpiece 30 in an imaging range having a predetermined size.

The robot 10, according to the first embodiment, is configured to move the camera 20 connected to the link 16 via the joint J6 by operating using data of a teaching point, which is position and posture data, and is configured as a moving unit that moves the camera 20.

### Simulation Apparatus

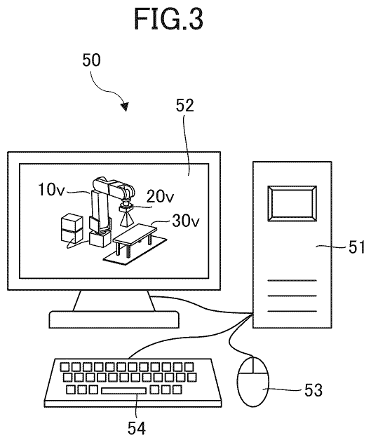

FIG. 3 is a view illustrating the simulation apparatus 50 according to the first embodiment. The simulation apparatus 50 includes a computer 51 serving as an apparatus body, a display 52 for performing display, and a keyboard 54 and a mouse 53 for performing input. In the first embodiment, a case where the simulation apparatus 50 is a desktop personal computer (PC) which is a general-purpose computer will be described as an example, but the present technology is not limited thereto. The simulation apparatus 50 may be, for example, a general-purpose computer such as a laptop PC, a tablet PC, or a smartphone, or a teaching pendant.

An image for teaching and program editing by the operator is displayed on the display 52 serving as a display unit. In addition, a robot 10v, a workpiece 30v, and the like are displayed in a virtual space on the display 52 in order to confirm an operation of the robot 10 by teaching or program editing. In the following description, an object displayed in the virtual space will be described with a reference sign appended with “v” at the end of the reference sign. For example, the robot 10 displayed in the virtual space is referred to as the robot 10v, and the workpiece 30 displayed in the virtual space is referred to as the workpiece 30v.

### Control Block Diagram of Robot System

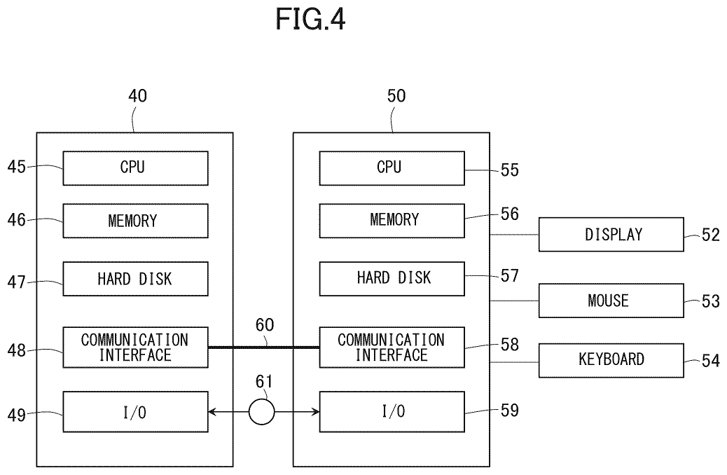

FIG. 4 is a control block diagram illustrating hardware configurations of an information processing apparatus, i.e., an information processing unit, including the control apparatus 40 and the simulation apparatus 50. As illustrated in FIG. 4, the control apparatus 40 is implemented by a computer. The control apparatus 40 includes a central processing unit (CPU) 45 that is an example of a processor as an information processing unit of the control apparatus 40, and a memory 46 and a hard disk 47 as storage units. The control apparatus 40 further includes a communication interface 48 and an I/O 49. The CPU 45, the memory 46, the hard disk 47, the communication interface 48, and the I/O 49 are data-communicably connected to each other via a bus.

The memory 46 includes, for example, a read only memory (ROM) and a random access memory (RAM). The memory 46 stores a basic program related to an operation of the computer, and temporarily stores various data such as an arithmetic processing result.

An arithmetic processing result of the CPU 45, various data acquired from the outside, and the like are recorded in the hard disk 47, and a program for causing the CPU 45 to execute various processes is recorded in the hard disk 47.

The communication interface 48 is connected to a communication interface 58 of the simulation apparatus 50 via an Ethernet (registered trademark) cable 60, thereby enabling transmission and reception of information to and from the simulation apparatus 50.

The I/O 49 is an interface with an external device, and is implemented by, for example, a recording disk drive. A removable memory 61 such as a recording disk or a storage device can be connected to the I/O 49. The I/O 49 can read various data, programs, and the like recorded in the removable memory 61.

As described above, the simulation apparatus 50 is implemented by a general-purpose computer. The simulation apparatus 50 includes a CPU 55 that is an example of a processor as an information processing unit of the simulation apparatus 50, and a memory 56 and a hard disk 57 as storage units. In addition, the simulation apparatus 50 includes the communication interface 58, an I/O 59, the display 52 described above as a display unit, and a mouse 53 and a keyboard 54 as input units. The display 52, the mouse 53, the keyboard 54, the CPU 55, the memory 56, the hard disk 57, the communication interface 58, and the I/O 59 are data-communicably connected to each other via a bus.

The memory 56 includes, for example, a ROM and a RAM, stores a basic program related to an operation of the computer, and temporarily stores various data such as an arithmetic processing result.

An arithmetic processing result of the CPU 55, various data acquired from the outside, and the like are recorded in the hard disk 57, and a program for causing the CPU 55 to execute various processes is recorded in the hard disk 57.

As described above, the communication interface 58 is connected to the communication interface 48 of the control apparatus 40 via the Ethernet (registered trademark) cable 60, thereby enabling transmission and reception of information to and from the control apparatus 40.

The I/O 59 is an interface with an external device. Furthermore, a removable memory 61 such as a recording disk or a storage device can be connected to the I/O 59. The I/O 59 can read various data, programs, and the like recorded in the removable memory 61.

### Acquisition of Data of Teaching Point for Robot

Next, a process executed by the simulation apparatus 50 to acquire data of a teaching point that is position and posture data of the robot 10 when moving the camera 20 of the robot 10 in a case of performing appearance inspection of the workpiece 30 by using the robot 10 will be described.

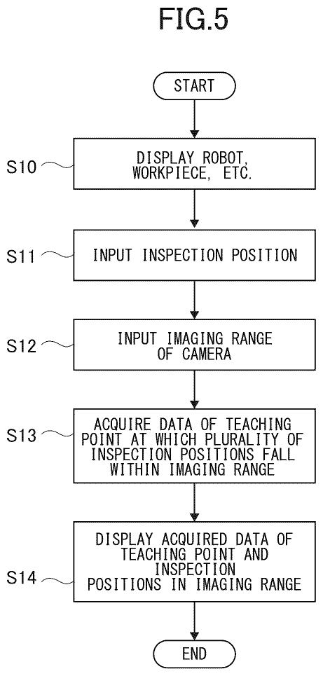

FIG. 5 is a flowchart illustrating a process of acquiring data of a teaching point for the robot 10, the process being executed by the CPU 55 of the simulation apparatus 50 according to the first embodiment. The simulation apparatus 50 acquires data of a teaching point for the robot 10 used when moving the robot 10 for imaging a plurality of inspection positions set on the workpiece 30 by the camera 20, by executing the processes of steps S10 to S14 illustrated in FIG. 5.

In other words, the CPU 55 acquires data of a teaching point to which the camera 20 is to be moved by the robot 10 so as to have a first positional relationship in which at least two inspection positions, i.e., a multiple portions, can fall within the imaging range of the camera 20 by executing the processes of steps S10 to S14 illustrated in FIG. 5. The CPU 55 that executes the processes of steps S10 to S14 implements an acquisition unit. Furthermore, data of a teaching point is included in information, serving as a first information, used when the camera 20 is moved by the robot so as to have the first positional relationship.

In the process of step S10, the CPU 55 displays the virtual space including the robot 10v and the workpiece 30v on the display 52 so that the operator can visually operate the robot 10v and the workpiece 30v (S10).

In the process of step S11, the CPU 55 receives an input of data of a plurality of inspection positions by the operator (S11).

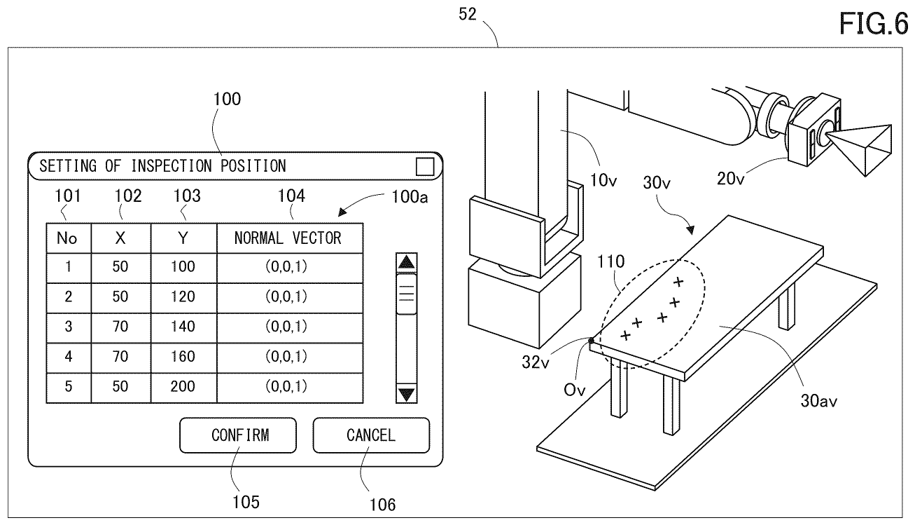

FIG. 6 is a view illustrating an example of a configuration of a screen displayed on the display 52 when an input of an inspection position by the operator is received. As illustrated in FIG. 6, the display 52 displays a position setting window 100 in which various types of information regarding the inspection position are displayed, the robot 10v, a camera 20v, the workpiece 30v, and the like in the virtual space.

The operator can set a position to be inspected on the workpiece 30v by selecting an arbitrary portion of the workpiece 30v with the mouse 53. The position to be inspected is displayed as a marker 110 in the virtual space. In other words, the CPU 55 is configured to set a plurality of portions to be imaged by the camera 20 in the workpiece 30v by executing a process of receiving points selected by the operator as inspection positions on the workpiece 30v displayed on the display 52.

With this configuration, the robot system 1 can allow the operator to select an arbitrary inspection position on the workpiece 30v displayed on the display 52, thereby improving work efficiency of the operator when setting an inspection position.

The set inspection position is displayed in a table 100a in the position setting window 100 together with a column 101 indicating a number (inspection number) of the inspection position, a column 102 indicating an x coordinate of the inspection position, and a column 103 indicating a y coordinate of the inspection position. In addition, the set inspection position is displayed in the table 100a together with information of a column 104 indicating a normal vector with respect to an inspection surface 30av which is a plane to be subjected to appearance inspection in the workpiece 30v.

In the example illustrated in FIG. 6, a coordinate origin Ov of an xyz coordinate system of the inspection position is a corner 32v on the inspection surface 30av of the workpiece 30v, and a unit of a component of each coordinate axis is millimeter. Therefore, for example, an inspection position of an inspection number 1 is a position of 50 mm in an x-axis direction and 100 mm in a y-axis direction from the coordinate origin Ov.

A confirm button 105 and a cancel button 106 are displayed in the position setting window 100. In a case where the confirm button 105 is selected, the CPU 55 proceeds from step S11 in the process of acquiring data of a teaching point for the robot 10 to step S12 which is the next step. In a case where the cancel button 106 is selected, the CPU 55 can stop the process of acquiring data of a teaching point for the robot 10.

When the confirm button 105 is selected, the CPU 55 creates a list of inspection positions in which each inspection position selected by the operator is associated with data of each inspection position displayed in the table 100a, and stores the list in the memory 56.

Once the operator selects an inspection position on the workpiece 30v, the CPU 55 changes a posture of the robot 10v displayed on the display 52 to a posture when the robot 10v approaches the inspection position selected by the operator. In addition, once the operator selects any information from inspection position data displayed in the table 100a, the CPU 55 changes the posture of the robot 10v to a posture when the robot 10v approaches an inspection position corresponding to the information selected by the operator.

With such a configuration, the simulation apparatus 50 enables the operator to confirm the posture of the robot 10 and the presence or absence of buffering between the robot 10 and a peripheral object when inspecting an inspection position selected by the operator.

The process of step S11 is included in a process of setting a portion to be imaged by the camera 20 in the workpiece 30. The CPU 55 that executes the process of step S11 implements a setting unit.

In the process of step S12, the CPU 55 receives an input of the imaging range of the camera 20 from the operator (S12). In this process, the CPU 55 receives an input of the size of the imaging range 22 by the operator.

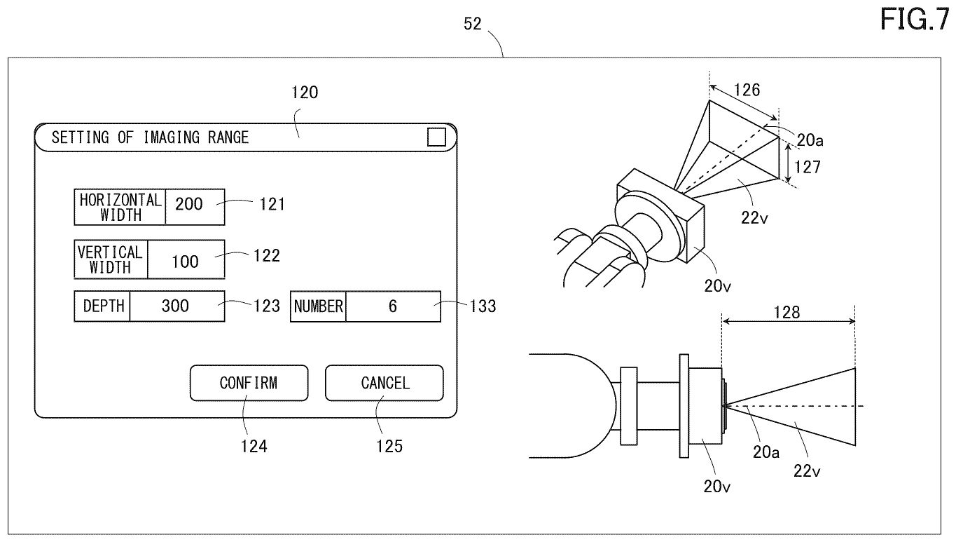

FIG. 7 is a view illustrating an example of a configuration of a screen displayed on the display 52 when an input of the imaging range of the camera 20 by the operator is received in the first embodiment. As illustrated in FIG. 7, the display 52 displays a range setting window 120 in which information regarding the imaging range of the camera 20 is displayed, and enlarged views of the robot 10v including the camera 20v and an imaging range 22v in the virtual space. In the example illustrated in FIG. 7, a perspective view and a side view are displayed as the enlarged views of the robot 10v.

A horizontal width input field 121 in which a horizontal width of the imaging range 22 can be input, a vertical width input field 122 in which a vertical width of the imaging range 22 can be input, and a depth input field 123 in which a depth of the imaging range 22 can be input are displayed in the range setting window 120. Here, the horizontal width of the imaging range 22 is a length in a horizontal direction with respect to a direction (optical axis direction) of an optical axis 20a of the camera 20. Furthermore, the vertical width of the imaging range 22 is a length in a vertical direction with respect to the optical axis direction of the camera 20. Furthermore, the depth of the imaging range 22 is a length in the optical axis direction of the camera 20. Furthermore, in the example illustrated in FIG. 7, a unit of a value input in each input field is millimeter.

The CPU 55 sets the size of the imaging range 22 by inputting values in the horizontal width input field 121, the vertical width input field 122, and the depth input field 123. As a result, the robot system 1 can set the size of the imaging range 22 that can satisfy a resolution of an image required for appearance inspection.

The CPU 55 changes a horizontal width 126, a vertical width 127, and a depth 128 of the imaging range 22v displayed on the display 52 according to the values input in the horizontal width input field 121, the vertical width input field 122, and the depth input field 123, respectively. In other words, the display 52 displays the imaging range 22v corresponding to the values input in the horizontal width input field 121, the vertical width input field 122, and the depth input field 123.

In addition, a number input field 133 in which an upper limit value of the number of inspection positions included in one imaging range 22 can be input is displayed in the range setting window 120. In a case where the number of inspection positions included in one imaging range 22 reaches a number set in the number input field 133, the CPU 55 calculates and acquires data of a teaching point for imaging in the imaging range 22.

With this configuration, the robot system 1 according to the first embodiment can prevent visibility of each inspection position from deteriorating due to imaging of many inspection positions by one imaging by the camera 20.

The CPU 55 implements a range setting unit, the CPU 55 performing setting of the length of the imaging range 22 in the horizontal direction and the length of the imaging range 22 in the vertical direction with respect to the optical axis direction of the camera 20 by inputting values in the horizontal width input field 121, the vertical width input field 122, and the depth input field 123, as setting of a predetermined size of the imaging range 22. The CPU 55 implements an upper limit value setting unit, the CPU 55 performs setting of the upper limit value of the number of inspection positions by inputting a value to the number input field 133.

A confirm button 124 and a cancel button 125 are displayed in the range setting window 120. In a case where the confirm button 124 is selected, the CPU 55 proceeds from step S12 in the process of acquiring data of a teaching point for the robot 10 to step S13 which is the next step. In a case where the cancel button 125 is selected, the CPU 55 can stop the process of acquiring data of a teaching point for the robot 10.

In the process of step S13, the CPU 55 executes a process of calculating and acquiring data of a teaching point at which a plurality of inspection positions fall within the imaging range 22 of the camera 20 based on input information (S13). In this process, the CPU 55 calculates and acquires data of a teaching point at which inspection positions are included in a rectangle having the horizontal width 126 and the vertical width 127 at a position of the depth 128 of the imaging range 22.

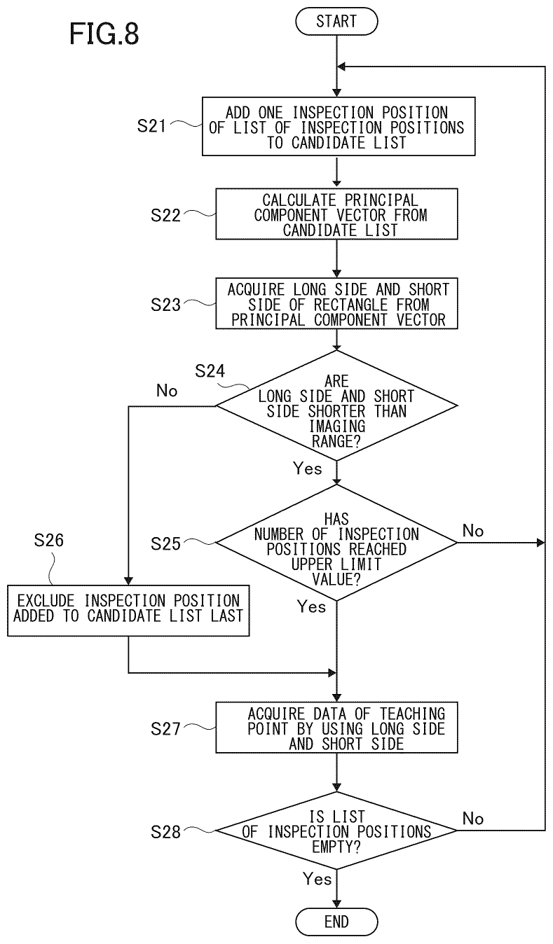

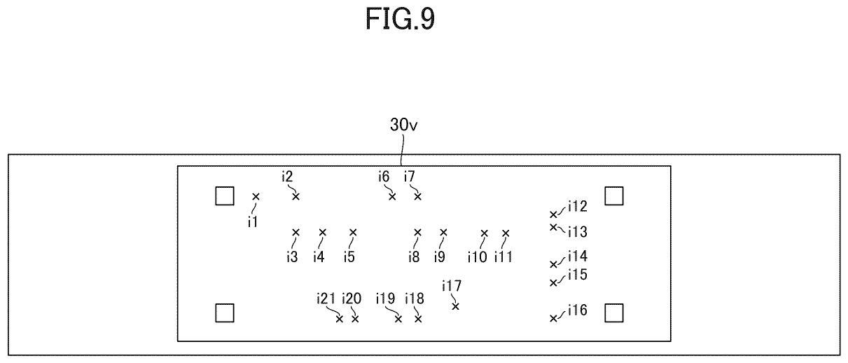

Details of the process of step S13 will be described with reference to the flowchart illustrated in FIG. 8 and a case where inspection positions i1 to i21 illustrated in FIG. 9 are set on the workpiece 30v. The inspection positions i1 to i21 illustrated in FIG. 9 are set with inspection numbers 1 to 21, respectively.

FIG. 8 is a flowchart illustrating a process related to acquisition of data of a teaching point at which a plurality of inspection positions fall within the imaging range 22 of the camera 20, the process being executed by the CPU 55 in the process of step S13.

In the process of step S21, the CPU 55 selects an arbitrary inspection position from a plurality of inspection positions input by the operator and adds the selected inspection position to a list of inspection positions (candidate list) as candidates for acquisition of data of a teaching point (S21). In this process, the CPU 55 acquires data of an arbitrary inspection position from the list of inspection positions, and adds the acquired data of the inspection position to the candidate list.

The CPU 55 selects an inspection position based on different criteria between a case where data of any inspection position is not added to the candidate list and a case where data of any inspection position is added to the candidate list. In a case where data of any inspection position is not added to the candidate list, the CPU 55 selects an inspection position having the smallest inspection number in the list of inspection positions. In the example illustrated in FIG. 9, when none of the inspection positions i1 to i21 is added to the candidate list, the CPU 55 selects, as an inspection position to be added to the candidate list, the inspection position i1 with the inspection number 1 which is the smallest inspection number in the list of inspection positions.

In a case where data of any inspection position is added to the candidate list, the CPU 55 selects data of an inspection position located closest to the previously added inspection position. In the example illustrated in FIG. 9, in a case where the inspection position i2 is added to the candidate list next to the inspection position i1, the CPU 55 selects, as an inspection position to be added to the candidate list, the inspection position i3 located closest to the inspection position i2.

In the process of step S22, the CPU 55 performs principal component analysis on an inspection position added to the candidate list to calculate a principal component vector of the inspection position (S22). In this process, the CPU 55 first calculates a variance-covariance matrix VC1 by the following Formula.

$$vc = ( \begin{matrix}v ( x ) & vc ( x , y ) \\ vc ( x , y ) & v ( y )\end{matrix} ) \qquad Mathematical Formula 1$$

Here, v(x) and v(y) are variances at each inspection position, and vc(x,y) and vc(y,x) are covariances at each inspection position, and are calculated by a known method. The CPU 55 calculates eigenvalues and eigenvectors of the variance-covariance matrix VC1 by the principal component analysis, and calculates an eigenvector having the largest eigenvalue as the principal component vector.

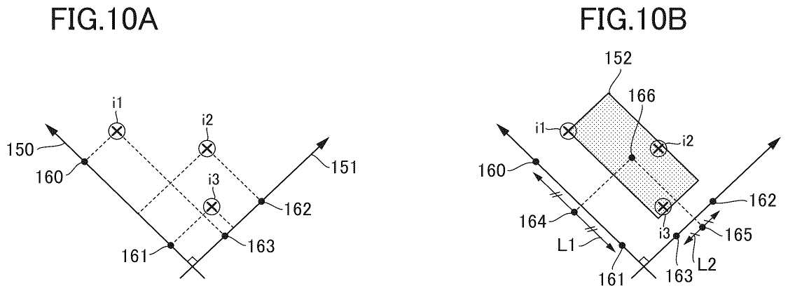

In the process of step S23, the CPU 55 acquires a rectangle including all the inspection positions from the principal component vector, and acquires a long side and a short side of the acquired rectangle (S23). Details of the process of step S23 will be described with reference to FIGS. 10A and 10B.

FIGS. 10A and 10B illustrate a case where the inspection positions i1 to i3 are added to the candidate list. FIG. 10A is a diagram illustrating a state in which principal component vectors and secondary component vectors of the inspection positions i1 to i3 are calculated. As illustrated in FIG. 10A, the CPU 55 calculates a principal component vector 150 as the principal component vectors of the inspection positions i1 to i3, and calculates a secondary component vector 151 perpendicular to the principal component vector 150.

The CPU 55 calculates a value 160 that is a maximum value and a value 161 that is a minimum value in a case where each inspection position is transferred to the principal component vector 150. In the example illustrated in FIG. 10A, a value obtained by transferring the inspection position i1 to the principal component vector 150 is the maximum value 160, and a value obtained by transferring the inspection position i3 to the principal component vector 150 is the minimum value 161.

In addition, the CPU 55 calculates a value 162 that is a maximum value and a value 163 that is a minimum value in a case where each inspection position is transferred to the secondary component vector 151. In the example illustrated in FIG. 10A, a value obtained by transferring the inspection position i2 to the secondary component vector 151 is the maximum value 162, and a value obtained by transferring the inspection position i1 to the secondary component vector 151 is the minimum value 163.

FIG. 10B is a diagram for acquiring a rectangle including all the inspection positions included in the candidate list from the values calculated in FIG. 10A. As illustrated in FIG. 10B, a rectangle 152 including the inspection positions i1 to i3 is acquired as a rectangle whose long side is parallel to the principal component vector 150 and whose short side is parallel to the secondary component vector 151. A length L1 of the long side of the rectangle 152 is calculated from a distance from the maximum value 160 to the minimum value 161, and a length L2 of the short side of the rectangle 152 is calculated from a distance from the maximum value 162 to the minimum value 163.

The CPU 55 acquires a central position 166 from a middle point 164 of the long side of the rectangle 152 and a middle point 165 of the short side of the rectangle 152. In other words, the CPU 55 acquires the central position 166 from the middle points 164 and 165 that are central values of the direction components. The central position 166 is used when data of a teaching point for the robot 10 is acquired in a later process.

As described above, the CPU 55 performs the principal component analysis on a plurality of inspection positions, and acquires a rectangular region including principal component vectors and secondary component vectors on an xy plane. As a result, when setting a region including a plurality of inspection positions, the robot system 1 can set the optimum region according to distribution of positions set as the inspection positions by calculating the principal component vectors and the secondary component vectors by the principal component analysis to set the region.

In the process of step S24, the CPU 55 determines whether or not the length L1 of the long side and the length L2 of the short side of the rectangle acquired in the process of step S23 are shorter than the horizontal width 126 and the vertical width 127 of the imaging range 22 of the camera 20 set in the process of step S12 (S24). In this process, the CPU 55 acquires the input horizontal width 126 and vertical width 127 of the imaging range 22, compares the longer one of the horizontal width 126 and the vertical width 127 with the length L1 of the long side of the rectangle, and compares the shorter one of the horizontal width 126 and the vertical width 127 with the length L2 of the short side of the rectangle.

For example, as illustrated in FIG. 7, in a case where a value “200” is input in the horizontal width input field 121 and a value “100” is input in the vertical width input field 122, the CPU 55 compares the horizontal width 126 of the imaging range 22 with the length L1 of the long side of the rectangle 152. In addition, the CPU 55 compares the vertical width 127 of the imaging range 22 with the length L2 of the short side of the rectangle 152. In this manner, the CPU 55 determines whether or not the entire rectangle acquired in the process of step S23 is included in the imaging range 22 set in the process of step S12.

In a case where it is determined that the entire rectangle acquired in the process of step S23 is included in the imaging range 22 set in the process of step S12 (Yes), the CPU 55 determines whether or not the number of inspection positions added to the candidate list has reached the upper limit number (S25). In this process, the CPU 55 determines whether or not the number of inspection positions added to the candidate list has reached the upper limit value input in the number input field 133 (see FIG. 7). In a case where it is determined that the number of inspection positions included in one imaging range 22 has reached the upper limit value input in the number input field 133 (Yes), the CPU 55 proceeds to step S27. On the other hand, in a case where it is determined that the number of inspection positions included in one imaging range 22 has not reached the upper limit value input in the number input field 133 (No), the CPU 55 determines that there is room to add an inspection position to the candidate list, and returns to step S21. As described above, the CPU 55 repeats the processes of steps S21 to S25 as long as it is determined that the entire rectangle acquired in the process of step S23 is included in the imaging range 22 set in the process of step S12 and the number of inspection positions has not reached the upper limit.

In a case where it is determined in the process of step S24 that the length of at least one of the long side or the short side of the rectangle acquired in the process of step S23 is longer than the horizontal width 126 or the vertical width 127 of the imaging range 22 (No), the CPU 55 proceeds to step S26. In step S26, the CPU 55 excludes data of an inspection position added to the candidate list last (S26).

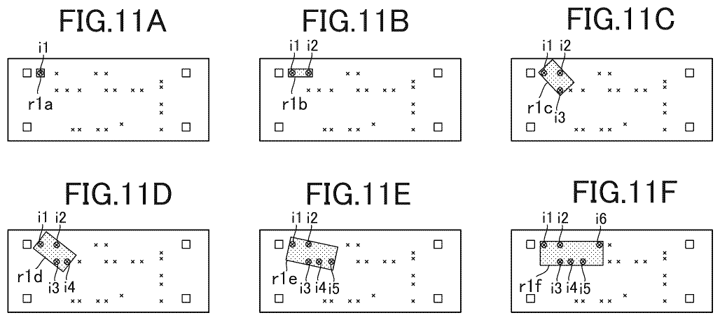

A flow of repeating the processes of steps S21 to S24 will be described with reference to FIGS. 11A to 11F. FIG. 11A is a view illustrating a state in which the inspection position i1 is added to the candidate list and a rectangle r1a including the inspection position i1 is acquired. FIG. 11B is a view illustrating a state in which the inspection position i2 is added to the candidate list and a rectangle r1b including the inspection positions i1 and i2 is acquired. FIG. 11C is a view illustrating a state in which the inspection position i3 is added to the candidate list and a rectangle r1c including the inspection positions i1 to i3 is acquired. FIG. 11D is a view illustrating a state in which the inspection position i4 is added to the candidate list and a rectangle r1d including the inspection positions i1 to i4 is acquired. FIG. 11E is a view illustrating a state in which the inspection position i5 is added to the candidate list and a rectangle r1e including the inspection positions i1 to i5 is acquired. FIG. 11F is a view illustrating a state in which the inspection position i6 is added to the candidate list and a rectangle r1f including the inspection positions i1 to i6 is acquired.

The CPU 55 repeats the processes of steps S21 to S24 until it is determined that a rectangle including all the inspection positions added to the candidate list is larger than the imaging range 22 or it is determined that the number of inspection positions added to the candidate list has reached the upper limit. In this manner, the CPU 55 acquires the rectangles r1a to r1f in this order. Therefore, in the example illustrated in FIGS. 11A to 11F, the size of the rectangle gradually increases in the order from the rectangle r1a to the rectangle r1f.

In the example illustrated in FIGS. 11A to 11F, it is determined that each of the rectangles r1a to r1e is entirely included in the imaging range 22. On the other hand, it is determined that the length L1 of the long side of the rectangle r1f is longer than the horizontal width 126 of the imaging range 22. In this case, the CPU 55 proceeds from the process of step S24 to the process of step S26, and deletes the inspection position i6 from the candidate list.

In the example illustrated in FIGS. 11A to 11F, the CPU 55 adds the inspection positions i1 to i5 to the candidate list by executing such a process and proceeds to step S27 in a state where the rectangle r1e is acquired.

In the process of step S27, the CPU 55 acquires data of a teaching point for the robot 10 by using the long side and the short side of the acquired rectangle (S27). In this process, the CPU 55 acquires the central position from the middle point of the long side and the middle point of the short side of the acquired rectangle.

The CPU 55 acquires data of a teaching point that is position and posture data of the robot 10 for imaging an inspection position added to the candidate list by using an x coordinate and a y coordinate of the central position and the principal component vector and the secondary component vector used to acquire the rectangle.

As described above, in a positional relationship between the camera 20 and the workpiece 30 in which a plurality of inspection positions can be included in the imaging range, the CPU 55 calculates data of a teaching point such that a central position of a rectangular region including the plurality of inspection positions is the center of the imaging range 22.

As a result, when imaging at least two inspection positions within the imaging range 22 whose size is set, the robot system 1 can include many inspection positions within one imaging range, so that an operation efficiency of the robot 10 and an operation time of the robot 10 can be reduced.

When a positional relationship between the camera 20 and the workpiece 30 in which the imaging range 22 can include the entire rectangular region is calculated by repeating the processes of steps S21 to S24, the CPU 55 adds a new inspection position outside the region to the region. The CPU 55 acquires a new region including the added inspection position, and verifies whether or not a positional relationship between the camera 20 and the workpiece 30 in which the imaging range 22 can include the entire new region is acquired.

When a positional relationship between the camera 20 and the workpiece 30 in which the imaging range 22 can include the entire new region is acquired as a result of the verification, the CPU 55 repeats the processes of steps S21 to S24 again. On the other hand, when a positional relationship between the camera 20 and the workpiece 30 in which the imaging range 22 can include the entire new region is not acquired as a result of the verification, the CPU 55 executes the process of step S26 and returns the setting of the region to a setting in which the inspection position added last to the new region is excluded. Then, the CPU 55 executes the process of step S27 for the positional relationship between the camera 20 and the workpiece 30 in which the imaging range 22 can include the entire region in a state in which the inspection position added last to the new region is excluded, and acquires data of a teaching point.

With such a configuration, the robot system 1 can set the maximum number of inspection positions that can be included in one imaging range 22, so that the number of times the robot 10 is operated to cause the camera 20 to perform imaging can be reduced. As a result, the operation time of the robot 10 can be reduced.

In the process of step S28, the CPU 55 excludes an inspection position added to the candidate list from the list of inspection positions, and then determines whether or not no inspection position is recorded in the list of inspection positions (S28). In this process, the CPU 55 excludes an inspection position added to the candidate list from the list of inspection positions since data of a teaching point for imaging by the camera 20 has been acquired for the inspection position added to the candidate list. Thereafter, the CPU 55 determines whether or not an inspection position is recorded in the list of inspection positions, thereby determining whether or not an inspection position for which data of a teaching point for imaging by the camera 20 has not been acquired is recorded in the list of inspection positions.

In a case where it is determined in the process of step S28 that an inspection position is recorded in the list of inspection positions (No), the CPU 55 determines that an inspection position for which data of a teaching point for imaging by the camera 20 has not been acquired remains, and returns to step S21. On the other hand, in a case where it is determined that no inspection position is recorded in the list of inspection positions (Yes), the CPU 55 determines that data of a teaching point for imaging by the camera 20 has been acquired for all the inspection positions recorded in the list of inspection positions. Then, the CPU 55 proceeds from the process of step S28 to the process of step S14.

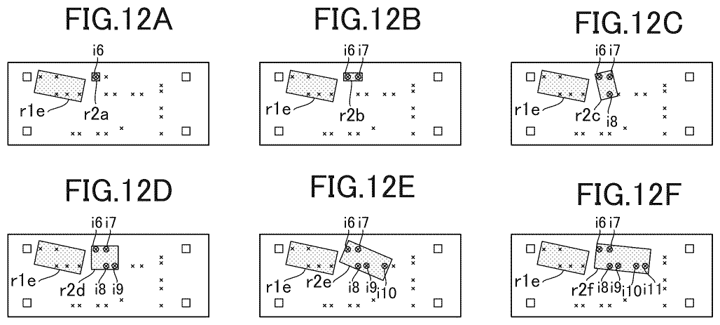

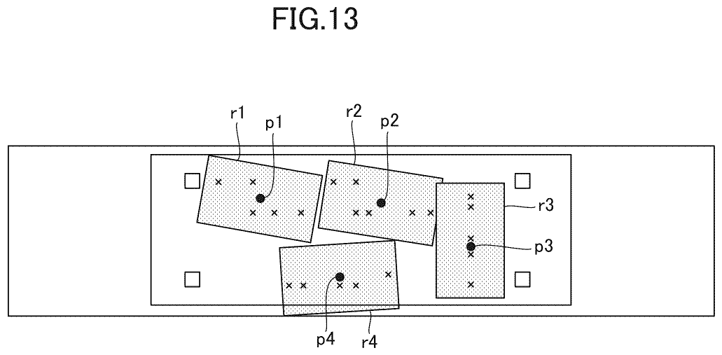

A flow of the processes of steps S21 to S28 for acquiring data of a teaching point for imaging by the camera 20 for all the inspection positions recorded in the list of inspection positions will be described with reference to FIGS. 12A to 12F and 13.

FIG. 12A is a view illustrating a state in which the inspection position i6 is added to the candidate list after the rectangle r1e used in acquiring the data of the teaching point for imaging the inspection positions i1 to i5 is acquired, and a rectangle r2a including the inspection position i6 is acquired. FIG. 12B is a view illustrating a state in which an inspection position i is added to the candidate list and a rectangle r2b including the inspection positions i6 and i is acquired. FIG. 12C is a view illustrating a state in which an inspection position i8 is added to the candidate list, and a rectangle r2c including the inspection positions i6 to i8 is acquired. FIG. 12D is a view illustrating a state in which an inspection position i9 is added to the candidate list, and a rectangle r2d including the inspection positions i6 to i9 is acquired. FIG. 12E is a view illustrating a state in which an inspection position i10 is added to the candidate list and a rectangle r2e including the inspection positions i6 to i10 is acquired. FIG. 12F is a view illustrating a state in which an inspection position i11 is added to the candidate list and a rectangle r2f including the inspection positions i6 to i11 is acquired.

In the example illustrated in FIGS. 12A to 12F, it is determined that each of the rectangles r2a to r2e is entirely included in the imaging range 22. On the other hand, it is determined that a length L1 of a long side of the rectangle r2f is longer than the horizontal width 126 of the imaging range 22. In this case, the CPU 55 proceeds from the process of step S24 to the process of step S26, and deletes the inspection position i11 from the candidate list.

In the example illustrated in FIGS. 12A to 12F, the CPU 55 adds the inspection positions i6 to i10 to the candidate list by executing such a process and proceeds to step S27 in a state where the rectangle r2e is acquired.

In the process of step S28, the CPU 55 excludes the inspection positions i6 to i10 from the list of inspection positions. In a case where it is determined that the inspection positions i11 to i21 are recorded in the list of inspection positions, the CPU 55 returns to step S21.

FIG. 13 is a view illustrating a state in which data of teaching points for imaging the inspection positions i1 to i21 are acquired by the processes of steps S21 to S28 by the CPU 55. As illustrated in FIG. 13, the data of the teaching point for imaging the inspection positions i1 to i5 is acquired from a central position p1 of a rectangle r1 including the inspection positions i1 to i5. The data of the teaching point for imaging the inspection positions i6 to i10 is acquired from a central position p2 of a rectangle r2 including the inspection positions i6 to i10. The data of the teaching point for imaging the inspection positions i11 to i15 is acquired from a central position p3 of a rectangle r3 including the inspection positions i11 to i15. Then, the data of the teaching point for imaging the inspection positions i16 to i21 is acquired from a central position p4 of a rectangle r4 including the inspection positions i16 to i21.

In this manner, the CPU 55 acquires data of a teaching point (data of a teaching point in the first positional relationship) to move to one positional relationship (first positional relationship) between the camera 20 and the workpiece 30 in which at least two inspection positions can be included in the imaging range 22. When there is an inspection position not included in the imaging range 22 in the first positional relationship, the CPU 55 acquires another positional relationship (second positional relationship) between the camera 20 and the workpiece 30 in which the inspection position not included in the imaging range 22 can be included in the imaging range. Then, the CPU 55 acquires data (second information) of a teaching point used when the camera 20 is moved by the robot 10 such that the camera 20 and the workpiece 30 have the second positional relationship, in addition to the data (first information) of the teaching point in the first positional relationship.

With such a configuration, the robot system 1 can acquire data of a plurality of teaching points corresponding to a plurality of inspection positions to be imaged by the camera 20 even when the inspection positions are set over a range wider than the imaging range 22. As a result, the robot system 1 can set any position and the number of inspection positions on the workpiece 30 regardless of the size of the imaging range 22, and can reduce man-hours of work related to the setting of inspection positions in the appearance inspection of the workpiece 30.

The CPU 55 proceeds to step S14 after executing the processes of steps S21 to S28 illustrated in FIG. 8 and ending the process of step S13 illustrated in FIG. 5. In the process of step S14, the CPU 55 displays, on the display 52, the acquired data of the teaching point and the inspection position included in the imaging range 22 when the camera 20 performs imaging based on the data of the teaching point (S14). Then, the CPU 55 ends the process of acquiring data of a teaching point for the robot 10.

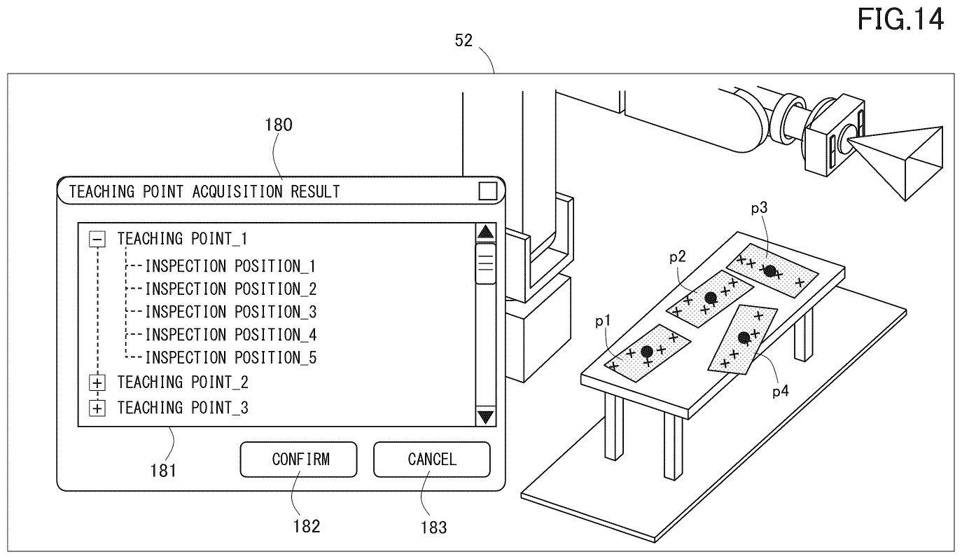

FIG. 14 is a view illustrating an example of a configuration of a screen when the acquired data of the teaching points and the inspection positions included in the imaging range 22 when the camera 20 performs imaging based on the acquired data of the teaching points are displayed on the display 52. As illustrated in FIG. 14, the display 52 displays an acquisition result window 180 for the data of the teaching points, the rectangles r1 to r5 which are regions including the respective inspection positions in the virtual space, and the central positions p1 to p5 of the rectangles r1 to r5.

In the acquisition result window 180, data of an inspection position included in the imaging range when imaging is performed based on data of a teaching point is displayed in association with the data of the teaching point by a tree view 181.

A confirm button 182 and a cancel button 183 are displayed in the acquisition result window 180. When the confirm button 182 is selected, the CPU 55 can adopt the acquired data of the teaching points and record the data in the memory 56. When the cancel button 183 is selected, the CPU 55 can discard the acquired data of the teaching points without adopting the data.

By executing such a process, the simulation apparatus 50 can create a robot program for performing the operation of the robot 10 and an imaging process by the camera 20 using acquired data of a teaching point in the subsequent process. The simulation apparatus 50 may be configured to automatically acquire the robot program from the acquired data of the teaching point.

### Summary of First Embodiment

As described above, the robot system 1 according to the first embodiment causes the robot 10 to move the camera 20 via the control apparatus 40 serving as the control unit based on a simulation result of the simulation apparatus 50 such that a positional relationship between the camera 20 and the workpiece 30 becomes the first positional relationship in which at least two inspection positions can be included in the imaging range. As a result, the robot system 1 can image a plurality of inspection positions included in the imaging range by one imaging, and the operation of the robot 10 can be made efficient and a time required for imaging the inspection positions can be shortened in the appearance inspection of the workpiece 30.

### Second Embodiment

Next, a robot system 1 according to a second embodiment will be described. The robot system 1 according to the second embodiment has a configuration capable of performing appearance inspection on an inspection target in a three-dimensional space. In this respect, the robot system 1 according to the second embodiment is different from that of the first embodiment described above. Since the other configurations are similar to those of the first embodiment, constituent elements common to those of the first embodiment are denoted by the same reference signs, control processes common to those of the first embodiment are denoted by the same step numbers, and a description thereof is omitted.

### Extraction of Data of Teaching Point for Robot

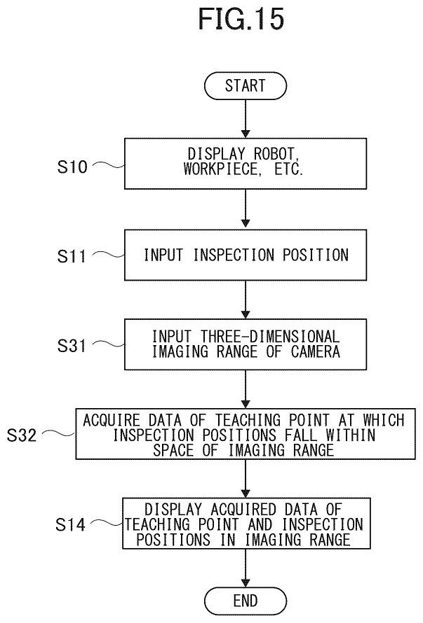

FIG. 15 is a flowchart illustrating a process of acquiring data of a teaching point for the robot 10, the process being executed by a CPU 55 of a simulation apparatus 50 according to the second embodiment. The simulation apparatus 50 extracts data of a teaching point for the robot 10 by executing the processes of steps S10, S11, S14, S31, and S32 illustrated in FIG. 15.

After executing the process of step S11, the CPU 55 executes the process of step S31. In the process of step S31, the CPU 55 receives an input of an imaging range of a camera 20 from an operator (S31).

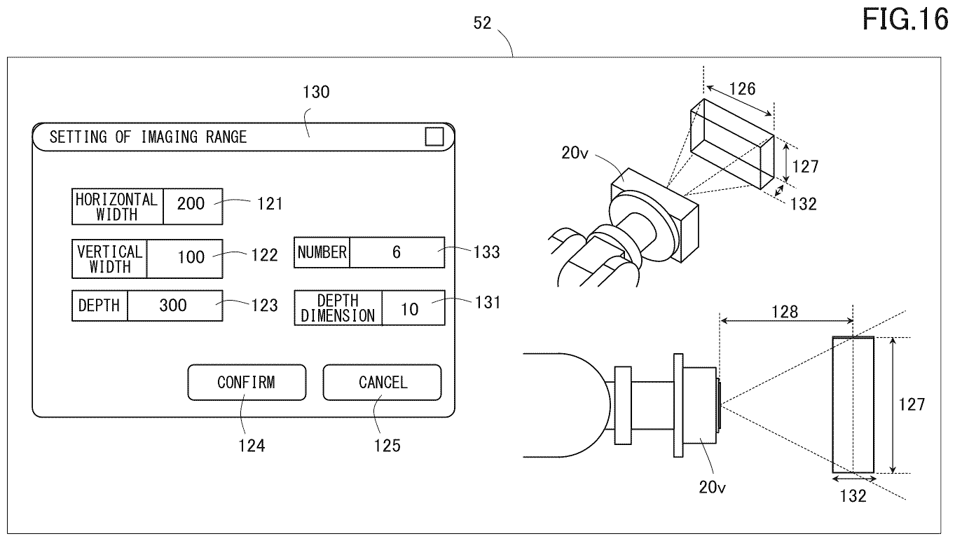

FIG. 16 is a view illustrating an example of a configuration of a screen displayed on a display 52 when an input of the imaging range of the camera 20 by the operator is received in the second embodiment. As illustrated in FIG. 16, the display 52 displays a range setting window 130 in which information regarding the imaging range of the camera 20 is displayed, and enlarged views of a robot 10v including a camera 20v and an imaging range 22v in a virtual space. In the example illustrated in FIG. 16, a perspective view and a side view are displayed as the enlarged views of the robot 10v.

A horizontal width input field 121, a vertical width input field 122, a depth input field 123, and a depth dimension input field 131, in which a depth dimension, which is a dimension of the imaging range in a depth direction based on a depth 128 of an imaging range 22 can be input, are displayed in the range setting window 130. Here, the depth dimension of the imaging range 22 is a length in a front-rear direction with respect to a direction (optical axis direction) of an optical axis 20a of the camera 20, and is a length in the front-rear direction based on a position set by the depth 128. In the example illustrated in FIG. 16, a unit of a value input in each input field is millimeter.

The CPU 55 changes a horizontal width 126, a vertical width 127, the depth 128, and a depth dimension 132v of the imaging range 22v displayed on the display 52 according to the values input in the horizontal width input field 121, the vertical width input field 122, the depth input field 123, and the depth dimension input field 131. As illustrated in FIG. 16, the depth dimension 132v is set based on the position of the depth 128. For example, when a value “300” is input in the depth input field 123 and a value “10” is input in the depth dimension input field 131, the depth dimension 132v is set in a range of 295 to 305 mm away from the camera 20 in the depth direction.

In the process of step S32, the CPU 55 extracts data of a teaching point at which a plurality of inspection positions fall within the imaging range 22 of the camera 20 based on input information (S32). In this process, the CPU 55 acquires data of a teaching point at which inspection positions are included in a rectangular parallelepiped having the position of the depth 128 as the center in the depth direction in the imaging range 22 and having the horizontal width 126, the vertical width 127, and the depth dimension 132.

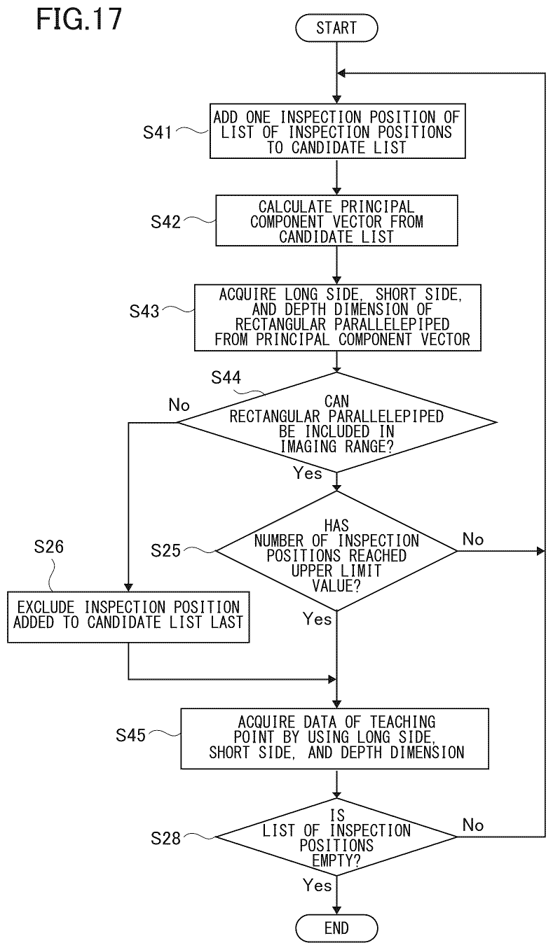

Details of the process of step S32 will be described with reference to the flowchart illustrated in FIG. 17. FIG. 17 is a flowchart illustrating a process related to acquisition of data of a teaching point at which a plurality of inspection positions fall within the imaging range 22 of the camera 20, the process being executed by the CPU 55 in the process of step S32.

In the process of step S41, the CPU 55 selects an arbitrary inspection position from a plurality of inspection positions input by the operator and adds the selected inspection position to a list of inspection positions (candidate list) as candidates for acquisition of data of a teaching point (S41). In this process, the CPU 55 acquires data of an arbitrary inspection position from the list of inspection positions, and adds the acquired data of the inspection position to the candidate list.

The CPU 55 selects an inspection position based on different criteria between a case where data of any inspection position is not added to the candidate list and a case where data of any inspection position is added to the candidate list. In a case where data of any inspection position is not added to the candidate list, the CPU 55 selects an inspection position having the smallest inspection number in the list of inspection positions.

In a case where data of any inspection position is added to the candidate list, the CPU 55 selects data of an inspection position located closest to the previously added inspection position. At this time, the CPU 55 according to the second embodiment sets a condition such that an angle between normal vectors is equal to or less than a preset threshold, in addition to an x coordinate and a y coordinate of the previously added inspection position. As a result, the CPU 55 can increase a possibility of selecting a plurality of inspection positions belonging to the same plane.

In the process of step S42, the CPU 55 performs principal component analysis on an inspection position added to the candidate list to calculate a principal component vector of the inspection position (S42). In this process, the CPU 55 first calculates a variance-covariance matrix VC2 by the following

$$Formula .$$

$$vc 2 = ( \begin{matrix}v ( x ) & vc ( x , y ) & vc ( x , z ) \\ ( vc ( y , x ) & v ( y ) & v ( y , x ) \\ vc ( z , x ) & vc ( z , y ) & v ( z )\end{matrix} ) \qquad Mathematical Formula 2$$

Here, v(x), v(y), and v(z) are variances at each inspection position, and vc(x,y), vc(x,z), vc(y,x), vc(y,z), vc(z,x), and vc(z,y) are covariances at each inspection position, and are calculated by a known method. The CPU 55 calculates eigenvalues and eigenvectors of the variance-covariance matrix VC2 by the principal component analysis, and calculates an eigenvector having the largest eigenvalue as the principal component vector.

In the process of step S43, the CPU 55 acquires a rectangular parallelepiped including all the inspection positions from the principal component vector, and acquires a long side, a short side, and a depth dimension of the acquired rectangular parallelepiped (S43). In this process, the CPU 55 acquires a rectangular parallelepiped from the principal component vector, a secondary component vector, and a normal vector. The CPU 55 calculates, as the secondary component vector, an eigenvector having the second largest eigenvalue among the eigenvectors calculated in the process of step S42. In addition, the CPU 55 calculates, as the normal vector, an eigenvector having the third largest eigenvalue among the eigenvectors calculated in the process of step S42.

In the process of step S44, the CPU 55 determines whether or not the entire rectangular parallelepiped acquired in the process of step S43 is included in a rectangular parallelepiped having the position of the depth 128 as the center in the depth direction in the imaging range 22 of the camera 20 set in the process of step S31 (S44). In this process, the CPU 55 determines whether or not the length of the long side, the length of the short side, and the depth dimension of the rectangular parallelepiped acquired in the process of step S43 are shorter than the horizontal width, the vertical width, and the depth dimension of the rectangular parallelepiped set in the process of step S31.

In a case where it is determined that the entire rectangular parallelepiped acquired in the process of step S43 is included in the rectangular parallelepiped of the imaging range 22 set in the process of step S31 (Yes), the CPU 55 determines that there is room to add an inspection position to the candidate list, and returns to step S41. As described above, the CPU 55 repeats the processes of steps S41 to S44 as long as it is determined that the entire rectangular parallelepiped acquired in the process of step S43 is included in the rectangular parallelepiped of the imaging range 22 set in the process of step S31.

On the other hand, in a case where it is determined that a part of the rectangular parallelepiped acquired in the process of step S43 is not included in the rectangular parallelepiped of the imaging range 22 (No), the CPU 55 proceeds to step S26.

In a case where it is determined in the process of step S25 that the number of inspection positions included in the imaging range 22 has reached an upper limit value (Yes), and after the process of step S26 is executed, the CPU 55 proceeds to step S45. In the process of step S45, the CPU 55 acquires data of a teaching point for the robot 10 by using the long side, the short side, and the depth dimension of the acquired rectangular parallelepiped (S45). In this process, the CPU 55 acquires a central position from a middle point of the long side, a middle point of the short side, and a middle point of the depth dimension of the acquired rectangular parallelepiped.

The CPU 55 acquires data of a teaching point for imaging an inspection position added to the candidate list by using an x coordinate, a y coordinate, and a z coordinate of the central position and the principal component vector, the secondary component vector, and the normal vector used to acquire the rectangular parallelepiped.

### Summary of Second Embodiment

As described above, the robot system 1 according to the second embodiment causes the robot 10 to move the camera 20 such that a positional relationship between the camera 20 and a workpiece 30 becomes the first positional relationship in which at least two inspection positions can be included in the imaging range. At this time, the robot system 1 can include a plurality of inspection positions existing at different positions in the optical axis direction of the camera 20 on the workpiece 30 in one imaging range by setting the depth dimension for the imaging range. As a result, the robot system 1 can image a plurality of inspection positions existing at different positions in the optical axis direction and included in the imaging range by one imaging, and the operation of the robot 10 can be made efficient and a time required for imaging the inspection positions can be shortened in the appearance inspection of the workpiece 30.

### Third Embodiment

Next, a robot system 1 according to a third embodiment will be described. The robot system 1 according to the third embodiment is configured to determine whether or not the robot 10 can be operated based on acquired data of a teaching point. The robot system 1 according to the third embodiment is configured to acquire an operation time of the robot 10 when the robot 10 is operated based on acquired data of a teaching point. In these respects, the robot system 1 according to the third embodiment is different from the first and second embodiments described above. Since the other configurations are similar to those of the first and second embodiments, constituent elements common to those of the first and second embodiments are denoted by the same reference signs, control processes common to those of the first and second embodiments are denoted by the same step numbers, and a description thereof is omitted.

### Acquisition of Data of Teaching Point for Robot

A simulation apparatus 50 according to the third embodiment is configured such that data of positions and three-dimensional shapes of each constituent element of the robot 10, a camera 20, and a workpiece 30 and an object (peripheral object) present around each constituent element can be set by an operator. The simulation apparatus 50 is configured to be able to verify whether or not interference occurs between each constituent element and a peripheral object when the robot 10 is moved. This will be described below in more detail.

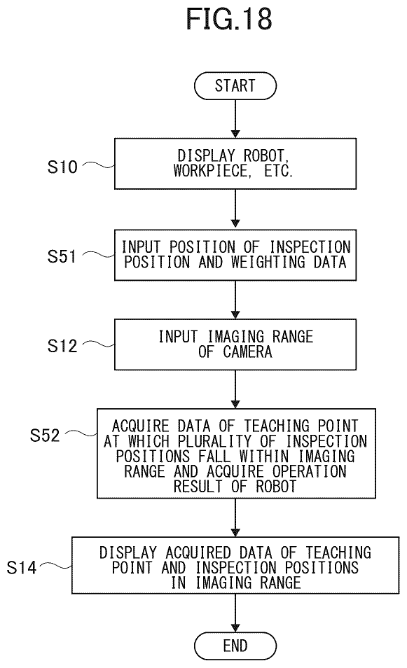

FIG. 18 is a flowchart illustrating a process of acquiring data of a teaching point for the robot 10, the process being executed by a CPU 55 of the simulation apparatus 50 according to the third embodiment. The simulation apparatus 50 acquires data of a teaching point for the robot 10 by executing the processes of steps S10, S12, S14, S51, and S52 illustrated in FIG. 18.

After executing the process of step S10, the CPU 55 executes the process of step S51. In the process of step S51, the CPU 55 receives an input of data of a plurality of inspection positions by an operator in the process of step S51 (S51). In this process, the CPU 55 according to the third embodiment acquires an inspection number, a position, and a normal vector from the data of the inspection positions selected by the operator, and receives an input of weighting data indicating a priority of the inspection position.

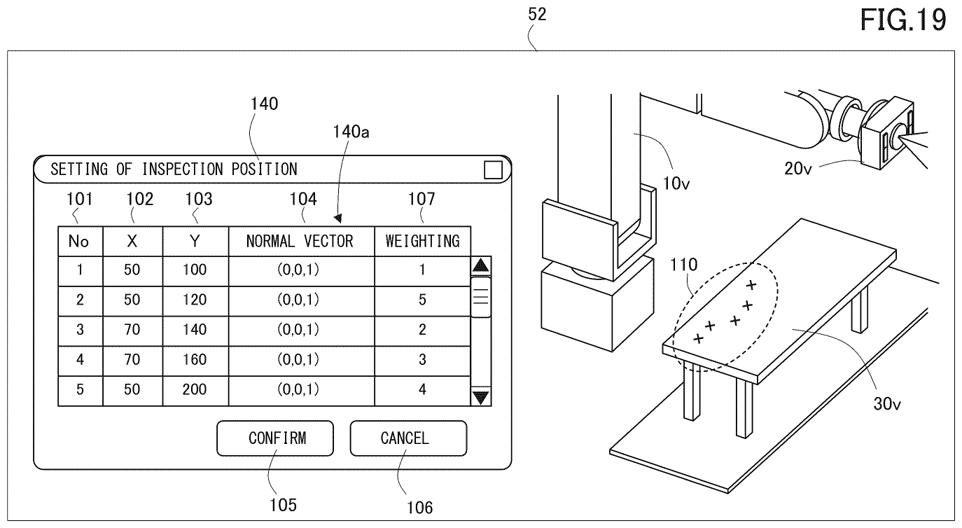

FIG. 19 is a view illustrating an example of a configuration of a screen displayed on a display 52 when an input of data of an inspection position by the operator is received. As illustrated in FIG. 19, the display 52 displays a position setting window 140 in which various types of information regarding the inspection position are displayed, a robot 10v, a camera 20v, a workpiece 30v, and the like in a virtual space.

In the third embodiment, a weighting input field 107 in which weighting data for setting the priority of an inspection position is displayed in a table 140a of the position setting window 140. The operator can select the weighting input field 107 of each inspection position and input an arbitrary numerical value as the weighting data.

After executing the process of step S12, the CPU 55 executes the process of step S52. In the process of step S52, the CPU 55 acquires data of a teaching point based on input information and acquires an operation result when the robot 10 is operated based on the data of the teaching point (S52). In this process, the CPU 55 acquires data of a teaching point at which inspection positions are included in a rectangle having a horizontal width 126 and a vertical width 127 in an imaging range 22. In addition, the CPU 55 acquires a determination result as to whether or not the robot 10 can be operated and an operation time as the operation result when the robot 10 is operated based on the acquired data of the teaching point.

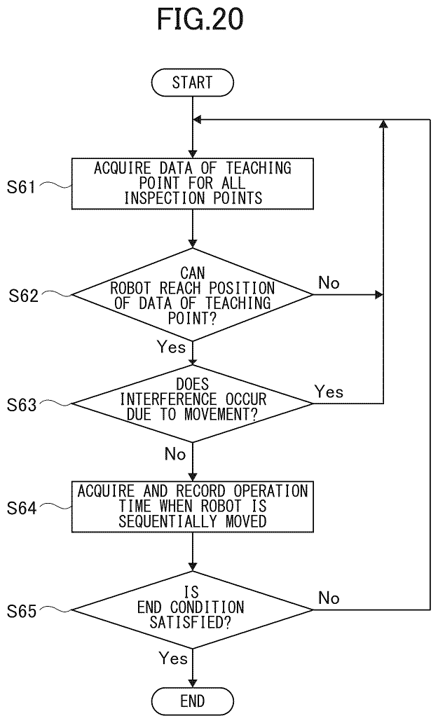

Details of the process of step S52 will be described with reference to the flowchart illustrated in FIG. 20. FIG. 20 is a flowchart illustrating a process related to acquisition of data of a teaching point at which a plurality of inspection positions fall within the imaging range 22 of the camera 20, the process being executed by the CPU 55 in the process of step S52.

First, the CPU 55 acquires data of a teaching point for operating the robot 10 (S61). In this process, the CPU 55 executes a process related to acquisition of data of a teaching point illustrated in FIG. 8. In the process of step S61, the CPU 55 repeats a process of acquiring data of a teaching point a plurality of times until there is no data of an inspection position stored in a list of inspection positions, and acquires data of a plurality of teaching points for imaging a plurality of inspection positions.

The CPU 55 according to the third embodiment has a configuration in which a criterion for selecting an inspection position is different from that of the first embodiment in a case where data of any inspection position is not added to a candidate list. In a case of executing the process of step S61 next to the process of step S12, the CPU 55 selects an inspection position for which the largest value is set as weighting data among inspection positions stored in the list of inspection positions. In a case where there are a plurality of inspection positions for which the largest value is set as the weighting data, the CPU 55 adds one inspection position randomly selected from the plurality of inspection positions using a random number to the candidate list.

As a result, in the robot system 1, the operator can control an order in which inspection positions are selected by the simulation apparatus 50, and the operator can adjust the operation of the robot 10 based on acquired data of a teaching point.

In a case where data of any inspection position is added to the candidate list, the CPU 55 selects data of an inspection position located closest to the previously added inspection position.

The CPU 55 may be configured to add, to the candidate list, data of an inspection position located near an inspection position having the highest priority among the inspection positions added to the candidate list.

With such a configuration, the robot system 1 can acquire data of a teaching point to which the camera 20 is moved by the robot 10 such that an inspection position having a higher priority among a plurality of inspection positions added to the candidate list is closer to the center of the imaging range 22 than the other inspection positions. As a result, the robot system 1 can make an inspection position having a higher priority set by the operator than the other inspection positions be substantially in the vicinity of the center of the captured image.

The CPU 55 is configured to change the order of acquiring data of inspection positions when returning from the processes of steps S62, S63, and S65 described below to the process of step S61. In other words, the CPU 55 is configured to change a combination of at least two inspection positions included in the imaging range 22 and acquire data of a teaching point when returning from the processes of steps S62, S63, and S65 to the process of step S61.

In the process of step S62, the CPU 55 determines whether or not the robot 10 can reach the position of the acquired data of the teaching point (S62). In this process, the CPU 55 acquires an inverse kinematic solution for the position indicated by the acquired data of the teaching point to verify whether or not the robot 10 can reach the position. A known method adapted to the configuration of the robot 10 is used as a method for acquiring the inverse kinematics solution.

In a case where the inverse kinematic solution exists (Yes), the CPU 55 proceeds to step S63 since there is a control value of each of joints J1 to J6 of the robot 10 that can reach the position indicated by the data of the teaching point. On the other hand, in a case where the inverse kinematic solution does not exist (No), the CPU 55 returns to step S61 since the robot 10 cannot reach the position of the acquired data of the teaching point.

In this manner, the CPU 55 verifies whether or not the camera 20 can be moved by the robot 10 based on the acquired data of the teaching point so as to have the first positional relationship in which a plurality of inspection positions can be included in the imaging range 22. The CPU 55 proceeds to step S63 if the movement is possible, and returns to step S61 if the movement is not possible as a result of the verification.

As a result, when data of a teaching point to which the robot 10 actually cannot be moved is acquired, the robot system 1 can quickly acquire data of a teaching point again, and can prevent data of a teaching point to which the robot 10 cannot be moved from being acquired in advance.

In the process of step S63, the CPU 55 determines whether or not each constituent element such as the robot 10 interferes with a peripheral object when the robot 10 moves to the position of the acquired data of the teaching point (S63). In this process, the CPU 55 determines whether or not the robot 10 or the camera 20 interferes with the workpiece 30 when the robot 10 is moved to the position of the acquired data of the teaching point by using the data of the positions and three-dimensional shapes of each constituent element and a peripheral object input in advance. In addition, the CPU 55 determines whether or not the robot 10 or the camera 20 interferes with a peripheral object when moving the robot 10 to the position of the acquired data of the teaching point.

In a case where it is determined that neither the interference between constituent elements nor the interference between a constituent element and a peripheral object occurs due to the movement of the robot 10 using the acquired data of the teaching point (No), the CPU 55 proceeds to step S64. On the other hand, in a case where it is determined that at least one of the interference between the constituent elements or the interference between a constituent element and a peripheral object occurs due to the movement of the robot 10 using the acquired data of the teaching point (Yes), the CPU 55 returns to step S61.

As described above, the CPU 55 verifies whether or not at least one of the robot 10 or the camera 20 interferes with another object such as a peripheral object when the camera 20 is moved by the robot 10 based on the acquired data of the teaching point. In a case where it is determined that the interference does not occur as a result of the verification, the CPU 55 proceeds to step S64, and in a case where it is determined that the interference occurs, the CPU 55 returns to step S61.

As a result, when at least one of the robot 10 or the camera 20 interferes with another object such as a peripheral object, the robot system 1 can promptly re-acquire data of a teaching point, and can prevent data of a teaching point to which the robot 10 cannot be moved from being acquired in advance.

The CPU 55 that executes the processes of steps S62 and S63 implements a movement verification unit and an interference verification unit.

In the process of step S64, the CPU 55 acquires an operation time elapsed when the robot 10 is sequentially moved based on the acquired data of the teaching point (S64). In this process, the CPU 55 sequentially moves the robot 10 based on data of a plurality of teaching points acquired for all the inspection positions, and acquires an operation time elapsed when the robot 10 moves to all the positions of the data of the plurality of teaching points.

The CPU 55 stores the acquired operation time in a memory 56 in association with the acquired data of the teaching point, and the display 52 can notify the operator of the operation time when the robot 10 is sequentially moved based on the data of the teaching points.

Thus, the simulation apparatus 50 can cause the operator to evaluate acquired data of a teaching point by using an operation time elapsed when the robot 10 is sequentially moved based on the acquired data of the teaching point. In other words, the operation time associated with the acquired data of the teaching point functions as a value (evaluation value) for evaluating a result of operating the robot 10.

In the process of step S65, the CPU 55 determines whether or not a preset end condition is satisfied (S65). The simulation apparatus 50 is configured such that a target time of the operation time can be set in advance as the end condition for a process related to acquisition of data of a teaching point. In the process of step S65, the CPU 55 determines whether or not the acquired operation time is equal to or less than the target time.

In a case where it is determined that the acquired operation time exceeds the target time (No), the CPU 55 returns to step S61. On the other hand, in a case where it is determined that the acquired operation time is equal to or less than the target time (Yes), the CPU 55 ends the process and proceeds to step S14 when the end condition for the process related to acquisition of data of a teaching point at which a plurality of inspection positions fall within the imaging range 22 of the camera 20 is satisfied.

By executing the processes of steps S61 to S65, the simulation apparatus 50 can acquire an operation time when the robot 10 is sequentially moved based on acquired data of teaching points, and acquire data of a teaching point at which the robot 10 can be operated and to which the robot 10 can be moved within the target time.

### Summary of Third Embodiment

As described above, the robot system 1 according to the third embodiment causes the robot 10 to move the camera 20 such that a positional relationship between the camera 20 and a workpiece 30 becomes the first positional relationship in which at least two inspection positions can be included in the imaging range. At this time, the robot system 1 verifies whether or not the camera 20 can be moved by the robot 10. In addition, when the robot 10 moves the camera 20, the robot system 1 verifies whether or not at least one of the robot 10 or the camera 20 interferes with another object including a peripheral object. Then, the robot system 1 acquires data of a teaching point to which the robot 10 can move the camera 20 and to which the camera 20 can be moved without interference between the robot 10 and the camera 20 and another object including a peripheral object.

As a result, in the robot system 1, the workpiece 30 can be imaged by the camera 20 at each position of the camera 20 moved using acquired data of all teaching points, and a set inspection position can be imaged without omission and subjected to the appearance inspection.

In addition, since the robot system 1 can set the priority for an inspection position, the operator can adjust the operation of the robot 10 based on acquired data of a teaching point.

In addition, the robot system 1 sets the target time as the end condition, and acquires data of a teaching point such that an operation time elapsed when the robot 10 is sequentially moved based on data of teaching points acquired by the robot 10 is within the target time. As a result, the robot system 1 can keep a time required for imaging an inspection position within the target time in the appearance inspection of the workpiece 30.

### Fourth Embodiment

Next, a robot system 1 according to a fourth embodiment will be described. The robot system 1 according to the fourth embodiment is configured to set a position where a workpiece 30 is imaged by a camera 20 by an operator's operation and acquire data of a teaching point for moving a robot 10 to a corresponding position. In this respect, the robot system 1 according to the fourth embodiment is different from that of the first to third embodiments described above. Since the other configurations are similar to those of the first to third embodiments, constituent elements common to those of the first to third embodiments are denoted by the same reference signs, control processes common to those of the first to third embodiments are denoted by the same step numbers, and a description thereof is omitted.

### Acquisition of Data of Teaching Point for Robot

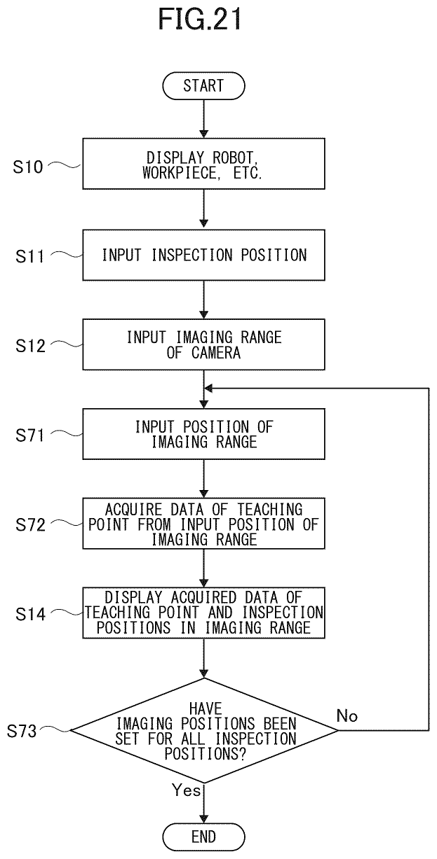

FIG. 21 is a flowchart illustrating a process of acquiring data of a teaching point for the robot 10, the process being executed by a CPU 55 of a simulation apparatus 50 according to the fourth embodiment. The simulation apparatus 50 acquires data of a teaching point for the robot 10 by executing the processes of steps S10 to S12, S71, S72, S14, and S73 illustrated in FIG. 21.

After executing the process of step S12, the CPU 55 receives an input of a position of an imaging range 22 by the operator (S71).

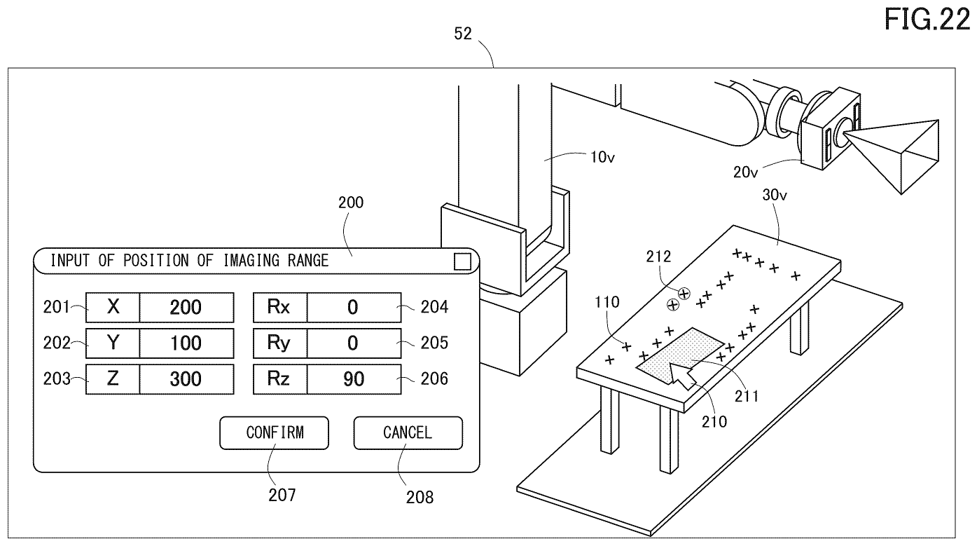

FIG. 22 is a view illustrating an example of a configuration of a screen displayed on a display 52 when an input of the position (imaging position) of the imaging range 22 by the operator is received. As illustrated in FIG. 22, the display 52 displays an imaging position setting window 200 in which various types of information of the imaging range 22 are displayed, a robot 10v, a camera 20v, a workpiece 30v, and the like in a virtual space.

As illustrated in FIG. 22, an x input field 201 in which an x coordinate of the imaging position can be input, a y input field 202 in which a y coordinate of the imaging position can be input, and a z input field 203 in which a z coordinate of the imaging position can be input are displayed in the imaging position setting window 200. In addition, an rx input field 204 in which a rotation angle coordinate of the imaging position around an x axis can be input and an ry input field 205 in which a rotation angle coordinate of the imaging position around a y axis can be input are displayed in the imaging position setting window 200. Then, an rz input field 206 in which a rotation angle coordinate of the imaging position around a z axis can be input is displayed in the imaging position setting window 200.

A mouse cursor 210 and a range model 211 indicating an imaging range are displayed on the display 52, and the range model 211 can be moved by performing dragging and dropping using the mouse cursor 210. The CPU 55 is configured to change a numerical value in each input field displayed in the imaging position setting window 200 following the movement of the range model 211.

As described above, the simulation apparatus 50 inputs a positional relationship between the workpiece 30 and the camera 20 when the camera 20 images a plurality of inspection positions by operating a mouse 53 and a keyboard 54 to input a numerical value in each input field displayed in the imaging position setting window 200. In addition, the simulation apparatus 50 inputs a positional relationship between the workpiece 30 and the camera 20 when the camera 20 images a plurality of inspection positions by operating the mouse 53 to operate the range model 211 displayed on the display 52. The mouse 53 and the keyboard 54 implement a positional relationship input unit.

A confirm button 207 and a cancel button 208 are displayed in the imaging position setting window 200. In a case where the confirm button 207 is selected, the CPU 55 proceeds from step S71 in the process of acquiring data of a teaching point for the robot 10 to step S72 which is the next step. In a case where the cancel button 208 is selected, the CPU 55 can stop the process of acquiring data of a teaching point for the robot 10.

When the confirm button 207 is selected, the CPU 55 stores an imaging position selected using the range model 211 by the operator in a memory 56. When the confirm button 207 is selected, the CPU 55 changes a display mode of a marker 110 at an inspection position included in the range model 211. For example, the CPU 55 displays the marker 110 before an imaging position is determined in a first shape of “x”. In addition, for example, the CPU 55 displays the marker 110 after the confirm button 207 is selected in a state in which the marker 110 is included in the range model 211 and an imaging position is determined, as a selected marker 212 in a second shape in which “x” is surrounded by “o”, the second shape being different from the first shape.

In the process of step S72, the CPU 55 acquires data of a teaching point used when the robot 10 is operated to move the camera 20 to an imaging position designated by the operator (S72). In this process, the CPU 55 acquires data of a teaching point used when operating the robot 10 such that the camera 20 is located at a central position of the imaging range 22 designated by the range model 211. After executing the process of step S72, the CPU 55 proceeds to step S14.

After executing the process of step S14, the CPU 55 proceeds to step S73. In the process of step S73, the CPU 55 determines whether or not imaging positions enabling imaging have been set for all the inspection positions (S73). In this process, the CPU 55 determines whether or not imaging positions enabling imaging are set for all the inspection positions by executing the processes of steps S71 and S72 a plurality of times. In a case where it is determined that imaging positions enabling imaging have not been set for all the inspection positions (No), the CPU 55 returns to step S71.

As described above, the CPU 55 displays an inspection position for which an imaging position is determined on the display 52 as the selected marker 212 in a display mode different from a display mode of an inspection position for which an imaging position has not been determined. As a result, the simulation apparatus 50 can notify the operator an inspection position for which an imaging position has not been set, and can assist an input of imaging positions for all the inspection positions.

In a case where it is determined that imaging positions enabling imaging have been set for all the inspection positions (Yes), the CPU 55 determines that acquisition of data of a teaching point used in the operation of the robot 10 that moves the camera 20 to each imaging position designated by the operator's operation has been completed. Then, the CPU 55 ends the process of acquiring data of a teaching point for the robot 10.

### Summary of Fourth Embodiment

As described above, in the robot system 1 according to the fourth embodiment, the camera 20 is moved by the robot 10 such that the positional relationship between the camera 20 and the workpiece 30 becomes a positional relationship input by the operator. As a result, the robot system 1 can image the workpiece 30 with the camera 20 at a position according to the intention of the operator.

### OTHER EMBODIMENTS

In the first to fourth embodiments, the robot system 1 is configured to move the camera 20 connected to the robot 10. However, the present technology is not limited thereto. The robot system 1 may have a configuration in which the workpiece 30 is connected to the link 16 of the robot 10 via the joint J6, and the camera 20 is installed on the fixing base. That is, the robot system 1 may have a configuration in which the robot 10 moves the workpiece 30 and the fixed camera 20 images the workpiece 30.

In the first to fourth embodiments, the CPU 55 is configured to be able to set an inspection position at which coordinates of the position can be represented by a point on the workpiece 30 as an inspection position to be imaged by the camera 20, but the present technology is not limited thereto. For example, the CPU 55 may be configured to be able to set a predetermined range in which coordinates can be represented by a plane or a space as a portion to be imaged by the camera 20.

In addition, the CPU 55 according to the first embodiment displays, on the display 52, acquired data of a teaching point and an inspection position included in the imaging range 22 when the camera 20 performs imaging based on the data of the teaching point, but the present technology is not limited thereto. The CPU 55 may be configured to display the workpiece 30 and the camera 20 when the camera 20 is moved by the robot 10 based on acquired data of a teaching point on the display 52.

With such a configuration, in the robot system 1, the workpiece 30 and the camera 20 at the time of imaging each inspection position based on acquired data of a teaching point are displayed on the display 52. As a result, the robot system 1 can notify the operator of the position of the camera 20 at the time of performing the appearance inspection.

In the first to fourth embodiments, the CPU 55 is configured to acquire data of a teaching point by using information regarding an inspection position and the imaging range 22 when acquiring the data of the teaching point, but the present technology is not limited thereto. The CPU 55 may be configured to use, when acquiring data of a teaching point, information regarding a distance between the camera 20 and the workpiece 30 in the optical axis direction of the camera 20 in addition to the information regarding the inspection position and the imaging range 22. With such a configuration, the CPU 55 may be configured to move the camera 20 by the robot 10 while maintaining a constant distance between the camera 20 and the workpiece 30 in the optical axis direction of the camera 20.

With such a configuration, in the robot system 1, the distance between the camera 20 and the workpiece 30 in the optical axis direction of the camera 20 is maintained during the movement of the camera 20, and thus, the size of the imaging range 22 during the movement of the camera 20 can also be maintained constant.

Furthermore, in the first to fourth embodiments, the CPU 55 is configured to be able to set the size of the imaging range 22 by inputting a numerical value in each of the horizontal width input field 121, the vertical width input field 122, and the depth input field 123, but the present technology is not limited thereto. The CPU 55 may be configured to set the size of the imaging range 22 according to a mouse dragging operation by the operator for the imaging range 22 displayed on the display 52.

In addition, in the third embodiment, the CPU 55 is configured to be able to set the target time as the end condition, but the present technology is not limited thereto. For example, the CPU 55 may be configured to set a processing time for executing the processes of steps S61 to S65, acquire data of teaching points until the processing time is reached, and acquire an operation time elapsed when the robot 10 is sequentially moved based on the acquired data of the teaching points.

With such a configuration, the robot system 1 can present, to the operator, a combination having the shortest operation time among combinations of acquisition of acquired data of teaching points and an operation time elapsed when the robot 10 is sequentially moved based on the acquired data of the teaching points.

In addition, in the fourth embodiment, the CPU 55 is configured to change, for example, the shape of the marker 110 such that the shape of the marker 110 before an imaging position is determined is different from that of the selected marker 212 after an imaging position is determined, but the present technology is not limited thereto. For example, the CPU 55 may be configured to display the marker 110 before an imaging position is determined in a first color, and display the selected marker 212 after an imaging position is determined in a second color different from the first color.

In addition, in the fourth embodiment, when receiving an input of an imaging position, the simulation apparatus 50 proceeds to the acquisition of data of a teaching point by selecting the confirm button 207 after setting one imaging position, but the present technology is not limited thereto. The simulation apparatus 50 may be configured to be able to set a plurality of imaging positions before acquiring data of a teaching point by continuously setting new imaging positions after setting one imaging position.

With such a configuration, the simulation apparatus 50 may display, in the imaging position setting window 200, an add button that is selected to determine the range model 211 currently displayed on the display 52 and display a new movable range model.

A control method and the control apparatus according to the present disclosure can be applied to software design and program creation for various machines and facilities such as an industrial robot, a service robot, and a processing machine operated by numerical control by a computer, in addition to production facilities. For example, a machine and equipment capable of automatically performing operations of expansion and contraction, bending and stretching, vertical movement, horizontal movement, or turning, or a combined operation thereof based on information of the storage device provided in the control apparatus are provided.

In addition, a method for controlling a robot system including a robot manipulator as a control target by executing the above-described control method is also included in embodiments of the present disclosure. In addition, an article manufacturing method for manufacturing an article by using a robot system that operates by executing the above-described control method is also included in embodiments of the present disclosure. In addition, a program capable of executing the above-described information processing and a computer-readable recording medium storing the program are also included in embodiments of the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-073767, filed Apr. 27, 2023, which is hereby incorporated by reference herein in its entirety.

What is claimed is:

1. An information processing apparatus comprising:
at least one memory storing instructions; and
at least one processor that, upon execution of the stored instructions, configures the at least one processor to
acquire data representing a plurality of portions of a workpiece to be imaged by an imaging unit and
acquire first information used in a case where a moving unit that is configured to move the workpiece or the imaging unit moves the workpiece or the imaging unit so as to have a first positional relationship in which a multiple number of portions among the plurality of portions of the workpiece are included in the imaging range.

2. The information processing apparatus according to claim 1, wherein in a case where there is a portion that is not included in an imaging range in the first positional relationship among the plurality of portions of the workpiece, execution of the stored instructions further configures the at least one processor to acquire second information used when the moving unit moves the workpiece or the imaging unit so as to have a second positional relationship in which the portion that is not included in the imaging range is caused to be included in the imaging range of the imaging unit.

3. The information processing apparatus according to claim 1, wherein execution of the stored instructions further configures the at least one processor to
acquire a first region including the multiple number of the portions of the workpiece and
acquire the first information for the first positional relationship in which a first region is included in the imaging range.

4. The information processing apparatus according to claim 3, wherein execution of the stored instructions further configures the at least one processor to
verify, in a case where the first positional relationship where the entire first region is included in the imaging range is acquired, a positional relationship between the workpiece and the imaging unit in which an entire second region acquired by adding a portion located outside the first region among the plurality of portions of the workpiece being included in the imaging range is acquirable, and
to acquire, in a case where the first positional relationship where the entire first region is included in the imaging range is not acquired, the first information by setting a positional relationship in which an entire region acquired by excluding a portion added last to the first region among the plurality of portions of the workpiece is included in the imaging range, as the first positional relationship.

5. The information processing apparatus according to claim 3, wherein execution of the stored instructions further configures the at least one processor to perform principal component analysis on the multiple number of the portions of the workpiece to acquire the first region.

6. The information processing apparatus according to claim 5, wherein execution of the stored instructions further configures the at least one processor to
acquire a central position of the first region such that
the central position is a center of the imaging range in the first positional relationship.

7. The information processing apparatus according to claim 1, execution of the stored instructions further configures the at least one processor to set priorities for the plurality of portions of the workpiece, and
preferentially select a portion of the work piece having a higher set priority from among the plurality of portions when selecting the multiple number of portions from among the plurality of portions of the workpiece.

8. The information processing apparatus according to claim 7, wherein execution of the stored instructions further configures the at least one processor to set the first positional relationship in such a manner that the multiple number of portions among the plurality of portions of the workpiece is included in the imaging range and the portion for which a higher priority is set among the multiple number of the portions is closer to the center of the imaging range than the others of the portions, and to acquire the first information used in a case where the moving unit moves the workpiece or the imaging unit.

9. The information processing apparatus according to claim 1, wherein execution of the stored instructions further configures the at least one processor to set an upper limit value of the number of portions of the workpiece to be imaged by the imaging unit and included in the imaging range.

10. The information processing apparatus according to claim 1, further comprising a display configured to display the workpiece.

11. The information processing apparatus according to claim 10, wherein execution of the stored instructions further configures the at least one processor to set points selected by an operator on the workpiece being displayed on the display as the plurality of portions of the workpiece to be imaged by the imaging unit.

12. The information processing apparatus according to claim 10, wherein the display is configured to display the workpiece or the imaging unit in a case where the moving unit moves the imaging unit so as to have the first positional relationship.

13. The information processing apparatus according to claim 10, wherein the display is configured to display the imaging range.

14. The information processing apparatus according to claim 1, wherein execution of the stored instructions further configures the at least one processor to verify that the moving unit can move the workpiece or the imaging unit so as to have the first positional relationship based on the first information.

15. The information processing apparatus according to claim 2, wherein execution of the stored instructions further configures the at least one processor to verify that at least one of the workpiece, the imaging unit, or the moving unit does not interfere with another object when the moving unit moves the workpiece or the imaging unit so as to have the first positional relationship based on the first information.

16. The information processing apparatus according to claim 1, wherein execution of the stored instructions further configures the at least one processor to acquire a plurality of pieces of information used in a case where the moving unit moves the workpiece or the imaging unit so as to have a plurality of positional relationships between the workpiece and the imaging unit including the first positional relationship to image all of the plurality of portions of the workpiece by the imaging unit,
acquire an operation time in a case where the moving unit sequentially moves the workpiece or the imaging unit based on the plurality of pieces of acquired information, and
change a combination of portions of the workpiece included in the imaging range in any one of the plurality of positional relationships in a case where the operation time exceeds a predetermined time, and acquire information used in a case where the moving unit moves the workpiece or the imaging unit so as to have the positional relationship in which the combination is changed.

17. The information processing apparatus according to claim 1, wherein execution of the stored instructions further configures the at least one processor to perform setting of the imaging range by setting of a length of the imaging range in a vertical direction with respect to an optical axis direction of the imaging unit and a length of the imaging range in a horizontal direction with respect to the optical axis direction.

18. The information processing apparatus according to claim 17, wherein execution of the stored instructions further configures the at least one processor to perform the setting of the imaging range by setting of a length of the imaging range in a front-rear direction with respect to the optical axis direction of the imaging unit.

19. The information processing apparatus according to claim 1, further comprising:
a positional relationship input unit configured to input a positional relationship between the workpiece and the imaging unit in a case where the imaging unit images the plurality of portions, and
wherein execution of the stored instructions further configures the at least one processor to cause the moving unit to move the workpiece or the imaging unit so as to have the positional relationship input from the positional relationship input unit.

20. The information processing apparatus according to claim 1, wherein execution of the stored instructions further configures the at least one processor to control the moving unit to move the workpiece or the imaging unit while maintaining a constant distance between the imaging unit and the workpiece in an optical axis direction of the imaging unit.

21. The information processing apparatus according to claim 1, wherein the predetermined imaging range is a range in which the multiple number of the portions are imagable at a predetermined resolution.

22. The information processing apparatus according to claim 21, wherein the resolution is a resolution set in appearance inspection of the workpiece.

23. A control method comprising:
setting a plurality of portions of a workpiece to be imaged by an imaging unit configured to image the workpiece in a predetermined imaging range; and
causing a moving unit to move the workpiece or the imaging unit so as to have a first positional relationship in which a multiple number of portions among the plurality of portions of the workpiece are included in the imaging range.

24. A robot system comprising:
an imaging unit;
a moving unit; and
a control apparatus configured to control the imaging unit and the moving unit to execute each process of the control method according to claim 23,
wherein the moving unit is a robot.

25. The information processing apparatus according to claim 1, wherein the moving unit is a robot.

26. An article manufacturing method comprising: manufacturing an article by using the robot system according to claim 24.

27. Anon-transitory computer-readable recording medium storing a program for causing a computer to execute the control method according to claim 23.
